(19) United States
(12) Patent Application Publication
(10) Pub. No.: US 2014/0297319 A1
(43) Pub. Date: Oct. 2, 2014

(54) Method And Apparatus For Clinically Dynamic Call Center Management

(71) Applicant: McKesson Financial Holdings, (US)

(72) Inventors: Eric Caballero, Lakeland, FL (US); Darcia Hess, Jensen Beach, FL (US); Paul Morris, Norcross, GA (US)

(73) Assignee: McKesson Financial Holdings, Hamilton (BM)

(21) Appl. No.: 13/852,374

(22) Filed: Mar. 28, 2013

(51) Int. Cl. G06F 19/00; H04M 3/51

(52) U.S. Cl. CPC G06F 19/322; H04M 3/5133
USPC 705/3

(57) ABSTRACT

A method, apparatus, and computer program product are described herein for providing a clinically dynamic call center management tool. As such, representatives of various clinics may provide and/or modify practice information, physician information and call scripts specific to their respective clinics. Users with publishing permissions, who may be affiliated with the call center, may publish the clinical content. Call center agents may therefore access clinically dynamic content that may be referenced during a call with a patient regarding a specific clinic.

### TECHNOLOGICAL FIELD

Various embodiments of the invention are related to a clinically dynamic call center management tool for managing calls on behalf of third party healthcare clinics.

### BACKGROUND

Some medical clinics, such as hospitals, doctor's offices, healthcare providers or the like, may outsource the management of inbound calls to a call center. Call center agents working at the call center may receive calls, manage scheduling of appointments, and handle other customer service operations on behalf of the clinic.

Call centers managing scheduling and various customer service issues on behalf of third party clinics may follow different procedures and/or call scripts depending on the clinic. As such, many call centers house large repositories of documents explaining various processes, clinical information, physician availability and specialties, and/or phone scripts. Upon receiving an inbound call, an agent must identify the correct clinical information based on the clinic for which a patient or other individual is calling. Often times, an agent must locate the information for a particular clinic (whether stored electronically or on paper), and may not know if the information is the most up to date available.

Additionally, the clinic may need to update the information provided to the agents, and ultimately the clinic's patients. The distribution of clinical information may be impeded by manual processes. For example, a representative of the clinic may email a new doctor's scheduling information and details to a call center supervisor. The distribution of information may now be dependent on the individual supervisor. The supervisor's availability may therefore prevent efficient dissemination of the information, resulting in agents being left with missing or otherwise outdated information.

Furthermore, as the number of clinics for which a call center receives calls increases, so does the likelihood of clinical information being erroneously associated with another clinic, and/or new or updated clinical information being overlooked or otherwise lost.

### BRIEF SUMMARY

Embodiments of the present invention, among other things, address the above-referenced problems by providing a clinically dynamic call center management tool. As such, representatives of various clinics may add or edit clinical content. Publishers may review the clinical content and approve or reject the clinical content. Agents may therefore receive updates of clinical information for dissemination to calling patients.

A method, apparatus, and computer program product are therefore provided for providing clinically dynamic call center management. A method is provided for managing a call center reference tool comprising authenticating, with a processor, a user affiliated with a clinic, receiving clinical content associated with the clinic, provided by the user, storing the clinical content in association with the clinic such that the clinical content is retrievable based on an indication of the clinic, receiving an indication of a request to view content associated with the clinic, the request initiated in response to an incoming call received at a call center regarding the clinic, wherein the call center is remote from the clinic, and causing display of the clinical content in response to the indication of the request.

The method may further include receiving a request from the user to publish the clinical content, inserting the request into a publisher work queue, and causing display of the request to the publisher, wherein the publisher is remote from the clinic. The method may further include receiving an indication of approval of the request, and publishing the clinical content so that the clinical content is available to call center agents. In some embodiments, the method includes receiving an indication of denial of the request, receiving publisher notes from the publisher, wherein the publisher notes include a reason for denial, and transmitting a communication notifying the clinic of the denial, wherein the communication comprises the publisher notes. The method may further include receiving a user-specified publishing date, wherein causing display of the clinical content occurs on and after the user-specified publishing data.

An apparatus is provided, including at least one processor and at least one memory including computer program code, the at least one memory and the computer program code configured to, with the processor, cause the device to at least authenticate a user affiliated with a clinic, receive clinical content associated with the clinic, provided by the user, store the clinical content in association with the clinic such that the clinical content is retrievable based on an indication of the clinic, receive an indication of a request to view content associated with the clinic, the request initiated in response to an incoming call received at a call center regarding the clinic, wherein the call center is remote from the clinic, and cause display of the clinical content in response to the indication of the request.

A computer program product is provided, comprising at least one non-transitory computer-readable storage medium having computer-executable program code instructions stored therein, the computer-executable program code instructions comprising program code instructions to authenticate a user affiliated with a clinic, receive clinical content associated with the clinic, provided by the user, store the clinical content in association with the clinic such that the clinical content is retrievable based on an indication of the clinic, receive an indication of a request to view content associated with the clinic, the request initiated in response to an incoming call received at a call center regarding the clinic, wherein the call center is remote from the clinic, and cause display of the clinical content in response to the indication of the request.

A system comprising a device and apparatus, the apparatus being remove from the device, is also provided. The device may be configured to receive logon credentials for a user affiliated with a clinic, receive clinical content associated with the clinic, and transmit the clinical content to an apparatus for managing clinical content. The apparatus may be configured to authenticate the user, receive the clinical content, and store the clinical content in association with the clinic such that the clinical content is retrievable based on an indication of the clinic, receive an indication of a request to view content associated with the clinic, the request initiated in response to an incoming call received at a call center regarding the clinic, wherein the call center is remote from the clinic, and cause display of the clinical content in response to the indication of the request.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of a system for providing clinically dynamic call center management, according to an example embodiment;

FIG. 2 is a block diagram of a clinically dynamic call center apparatus, according to an example embodiment;

FIG. 3 is a flowchart illustrating operations for providing clinically dynamic call center management, according to an example embodiment;

FIG. 4 is a flowchart illustrating operations for providing and publishing clinical content with a clinical system and clinically dynamic call center apparatus;

FIGS. 5A-5E are example displays for displaying clinical content, according to an example embodiment;

FIGS. 6A-6G are example displays for editing clinical content, according to an example embodiment;

FIGS. 7A-7B are example displays for publishing clinical content, according to an example embodiment; and

FIGS. 8A-8B are example displays for administering permissions for users, according to an example embodiment.

### DETAILED DESCRIPTION

Some embodiments will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As described above, current call center management processes often rely on manual processes to update clinical information that agents provide to inquiring patients. A clinically dynamic call center system may automate the process, thereby improving efficiency, as well as accuracy of the clinical content. Additionally or alternatively, a clinically dynamic call center system may ensure that only authorized individuals may publish clinical content. A clinically dynamic call center system may additionally provide configurable permissions so that the upload process may have varying approval requirements, depending on the clinic and/or individual user. As such, some clinical content may be made available immediately to agents, while other clinical content may require approval by a publisher.

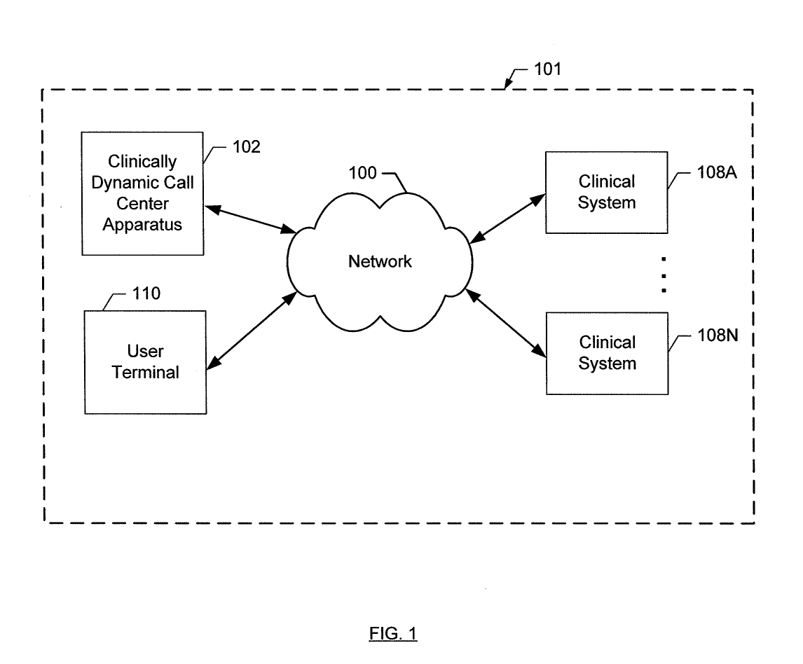

FIG. 1 is a block diagram of a system for providing clinically dynamic call center management, according to an example embodiment. It will be appreciated that the system 101 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for providing clinically dynamic call center management, numerous other configurations may also be used to implement embodiments of the present invention.

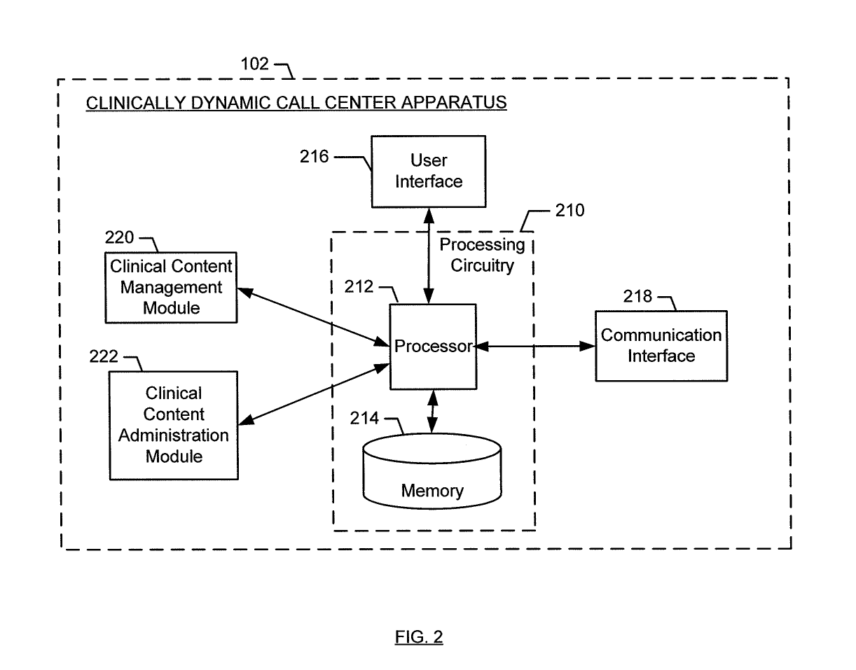

The system 101 may include a clinically dynamic call center apparatus 102 that may be configured to provide clinically dynamic call center management, as introduced above and described in further detail herein with respect to FIG. 2. The clinically dynamic call center apparatus 102 may communicate with any number of clinical systems 108, and/or any number of user terminals 110, among others. Depiction of ‘N’ clinical systems 108 is merely for example.

The clinical system 108 may be any system, server, server cluster, apparatus, database and/or the like configured by use at a clinic (e.g., a provider of medical care), to provide and/or collect data regarding the clinic, physicians, patients, and/or the like. The clinical system 108 may comprise scheduling information for upcoming appointments, and/or an interface for use in accessing and/or collecting patient data. The clinically dynamic call center apparatus 102 may communicate with clinical system 108 to receive and/or provide scheduling information and clinical content, for example.

Continuing with FIG. 1, system 101 may additionally and optionally comprise any number of user terminals 110, which may, for example, be embodied as a laptop computer, tablet computer, mobile phone, desktop computer, workstation, or other like computing device, and may be used to access the clinically dynamic call center 102 and/or clinical system 108. For example, a user terminal 110 may be used by a call center agent to access clinical content, and/or a user terminal 110 may be used by a representative of the clinic to provide clinical content. A user terminal 110 may be remote from the clinically dynamic call center apparatus 102, and/or clinical system 108, in which case the user terminal 110 may communicate with any of the respective apparatuses via network 100. Additionally or alternatively, the user terminal 110 may be implemented on clinically dynamic call center apparatus 102.

The clinically dynamic call center apparatus 102 may communicate with any of the clinical system 108, and/or user terminal 110 via any of a variety of methods dependent upon the configuration of the system 101. For example, in embodiments in which a clinically dynamic call center apparatus 102 is disposed remotely from any of the apparatuses, information, such as clinical content, may be transmitted, via a network 100, by a variety of connections. Network 100 may be embodied in a local area network, the Internet, any other form of a network, or in any combination thereof, including proprietary private and semi-private networks and public networks. The network 100 may comprise a wireline network, wireless network (e.g., a cellular network, wireless local area network, wireless wide area network, some combination thereof, or the like), or a combination thereof, and in some example embodiments comprises at least a portion of the Internet. As another example, a clinically dynamic call center apparatus 102 may be directly coupled to any of the clinical systems 108, and/or user terminal 110.

In some example embodiments, clinically dynamic call center apparatus 102 may be embodied as or comprise one or more computing devices, such as, by way of non-limiting example, a server, configured to access network 100. In some example embodiments, clinically dynamic call center apparatus 102 may be implemented as a distributed system or a cloud based entity that may be implemented within network 100. In this regard, clinically dynamic call center apparatus 102 may comprise one or more servers, a server cluster, one or more network nodes, a cloud computing infrastructure, some combination thereof, or the like.

An example embodiment of a clinically dynamic call center apparatus 102 is illustrated in FIG. 2. It should be noted that the components, devices, and elements illustrated in and described with respect to FIG. 2 below may not be mandatory and thus some may be omitted in certain embodiments. Additionally, some embodiments may include further or different components, devices, or elements beyond those illustrated in and described with respect to FIG. 2.

A clinically dynamic call center apparatus 102 may include processing circuitry 210, which may be configured to perform actions in accordance with one or more example embodiments disclosed herein. In this regard, the processing circuitry 210 may be configured to perform and/or control performance of one or more functionalities of the clinically dynamic call center apparatus 102 in accordance with various example embodiments. The processing circuitry 210 may be configured to perform data processing, application execution, and/or other processing and management services according to one or more example embodiments. In some embodiments, the clinically dynamic call center apparatus 102 or a portion(s) or component(s) thereof, such as the processing circuitry 210, may be embodied as or comprise a circuit chip. The circuit chip may constitute means for performing one or more operations for providing the functionalities described herein.

In some example embodiments, the processing circuitry 210 may include a processor 212 and, in some embodiments, such as that illustrated in FIG. 2, may further include memory 214. The processing circuitry 210 may be in communication with or otherwise control a user interface 216, a communication interface 218, clinical content management module 220, and/or clinical content administration module 222. As such, the processing circuitry 210 may be embodied as a circuit chip (e.g., an integrated circuit chip) configured (e.g., with hardware, software, or a combination of hardware and software) to perform operations described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of clinically dynamic call center apparatus 102 as described herein. The plurality of processors may be embodied on a single computing device or distributed across a plurality of computing devices collectively configured to function as the clinically dynamic call center apparatus 102. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA, or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the clinically dynamic call center apparatus 102. The memory 214 may be configured to store information, data, applications, instructions and/or the like for enabling the clinically dynamic call center apparatus 102 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets. Among the contents of the memory 214, applications may be stored for execution by the processor 212 to carry out the functionality associated with each respective application. In some cases, the memory 214 may be in communication with one or more of the processor 212, user interface 216, communication interface 218, clinical content management apparatus 220, and/or clinical content administration module 222 for passing information among components of clinically dynamic call center apparatus 102.

In some example embodiments, the processor 212 (or the processing circuitry 210) may be embodied as, include, or otherwise control a clinical content management module 220. As such, the clinical content management module 220 may be embodied as various means, such as circuitry, hardware, a computer program product comprising computer readable program instructions stored on a computer readable medium (for example, the memory 214) and executed by a processing device (for example, the processor 212), or some combination thereof. Clinical content management module 220 may be capable of communication with one or more of the processor 212, memory 214, user interface 216, communication interface 218, and clinical content administration module 222 to access, receive, and/or send data as may be needed to perform one or more of the functionalities of the clinical content management module 220, such as managing clinical content, as described herein. In some example embodiments, clinical content management module 220 may be implemented as a web service. It will be appreciated that implementing clinical content management module 220 as a web service is cited as a non-limiting example, and should not be construed to narrow the scope or spirit of the disclosure in any way.

In some example embodiments, the processor 212 (or the processing circuitry 210) may be embodied as, include, or otherwise control a clinical content administration module 222. As such, the clinical content administration module 222 may be embodied as various means, such as circuitry, hardware, a computer program product comprising computer readable program instructions stored on a computer readable medium (for example, the memory 214) and executed by a processing device (for example, the processor 212), or some combination thereof. Clinical content administration module 222 may be capable of communication with one or more of the processor 212, memory 214, user interface 216, communication interface 218, and clinical content management module 220 to access, receive, and/or send data as may be needed to perform one or more of the functionalities of the clinical content administration module 222, such as configuring permissions and settings for clinical content management, as described herein. In some example embodiments, clinical content administration module 222 may be implemented as a web service. It will be appreciated that implementing clinical content administration module 222 as a web service is cited as a non-limiting example, and should not be construed to narrow the scope or spirit of the disclosure in any way.

The user interface 216 may be in communication with the processing circuitry 210 to receive an indication of a user input at the user interface 216 and/or to provide an audible, visual, mechanical, or other output to the user. As such, the user interface 216 may include, for example, a keyboard, a mouse, a joystick, a display, a touch screen display, a microphone, a speaker, and/or other input/output mechanisms. As such, the user interface 216 may, in some example embodiments, provide means for user control of clinical content management operations and/or the like. In some example embodiments in which the clinically dynamic call center apparatus 102 is embodied as a server, cloud computing system, or the like, aspects of user interface 216 may be limited or the user interface 216 may not be present. In some example embodiments, one or more aspects of the user interface 216 may be implemented on a user terminal 110. Accordingly, regardless of implementation, the user interface 216 may provide input and output means to facilitate clinical content management in accordance with one or more example embodiments.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable clinically dynamic call center apparatus 102 to communicate with various systems over network 100. Accordingly, the communication interface 218 may, for example, include supporting hardware and/or software for enabling communications via cable, digital subscriber line (DSL), universal serial bus (USB), Ethernet, or other methods.

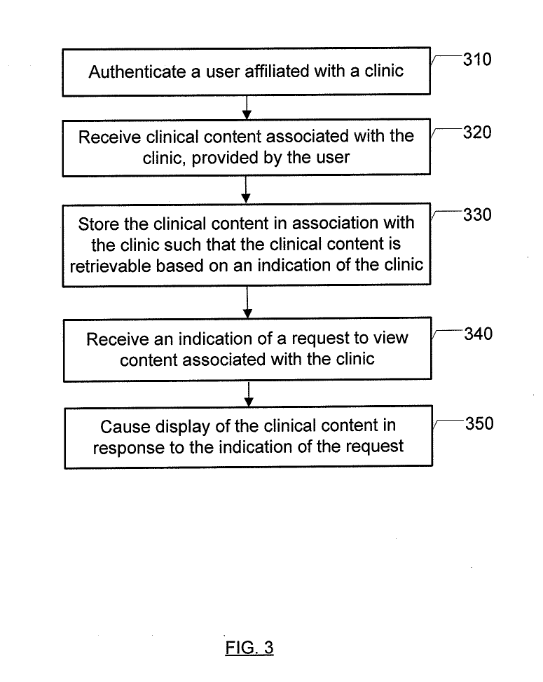

FIG. 3 is a flowchart illustrating operations for managing clinically dynamic content. At operation 310, the clinically dynamic call center apparatus 102 may be configured, such as with clinical content management module 220, communication interface 218, user interface 216, processor 212, or the like for authenticating a user affiliated with a clinic. As such, the clinically dynamic call center apparatus 102 may receive logon credentials that may be provided by a user of a clinical system 108. The user may be authorized to provide or otherwise modify clinical content on behalf of the associated healthcare provider. As such, the clinically dynamic call center apparatus 102 may authenticate a user to ensure the user is authorized to access the clinically dynamic call center apparatus 102. As the user makes a request to provide or otherwise modify clinical content, the clinical content administration module 222 may validate the specific permissions of the user.

As shown by operation 320, the clinically dynamic call center apparatus 102 may be configured, such as by communication interface 218, processor 212, user interface 216, clinical content management module 220, and/or the like for receiving clinical content associated with the clinic, provided by the user. The clinical content may be new or updated clinical content, such as clinical content described herein. Following receipt of such clinical content, the clinically dynamic call center apparatus 102 may, in some embodiments not shown, request approval from another user, based on the permissions of the user. The clinical content administration module 222 may be configured to determine the permissions, and generate notification to authorized users, such as a publisher, for approval, if necessary. In some embodiments, a user affiliated with the clinic may additionally provide a publish date in the future, indicating the clinical content should not be published immediately, but only after the publish date. This may allow a clinic to prepare clinical content in advance of changes to their practice and to include a publish date such as an effective date of the change.

At operation 330, the clinically dynamic call center apparatus 102 may include means, such as the processor 212, clinical content management module 220, and/or the like for storing the clinical content in association with the clinic such that the clinical content is retrievable based on the indication of the clinic. The clinical content may be stored to memory 214, and may be associated with the clinic.

Continuing to operation 340, the clinically dynamic call center apparatus 102, such as with communication interface 218 or the like, may receive an indication of a request to view content associated with the clinic, the request initiated in response to an incoming call received at a call center regarding the clinic, wherein the call center is remote from the clinic. As described above, a call center, which may be located remotely from the clinic, may be used to receive and handle incoming calls from patients, or the like. For example, a patient may call a particular clinic, and may be prompted by an automated menu selection. Upon selecting to schedule an appointment, the patient's call may be directed to the call center, and indication of a request to view content associated with the clinic may, thereafter, be received by the clinically dynamic call center apparatus 102. In some embodiments, the indication may be provided by a call center agent, selecting the clinic based on the line on which the incoming call is received, and using the user interface 216 of the clinically dynamic call center apparatus 102. In some embodiments, the indication may be automatically transmitted to the clinically dynamic call center apparatus 102 from a teleprompting system.

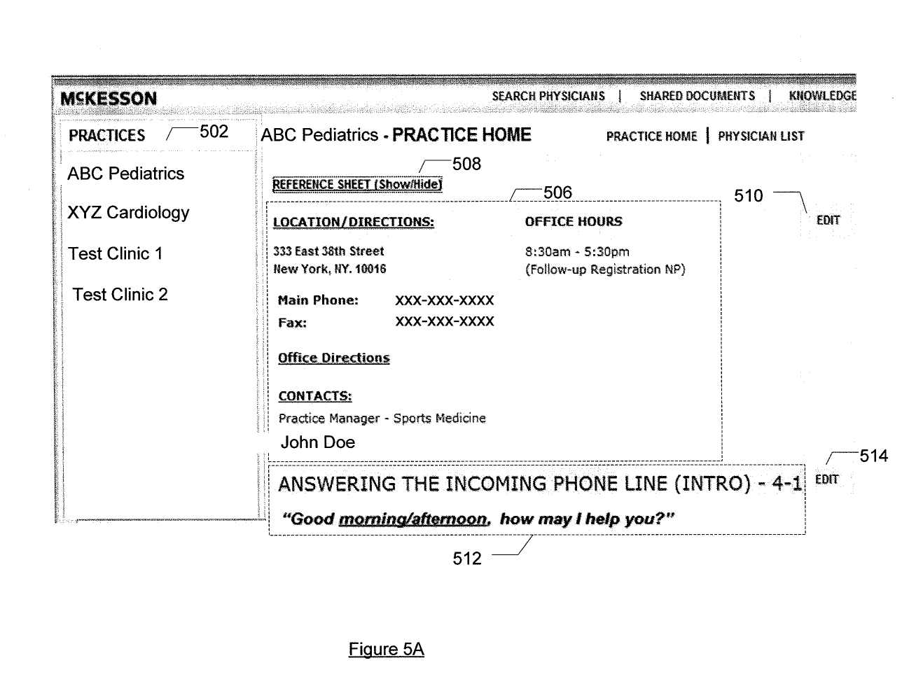

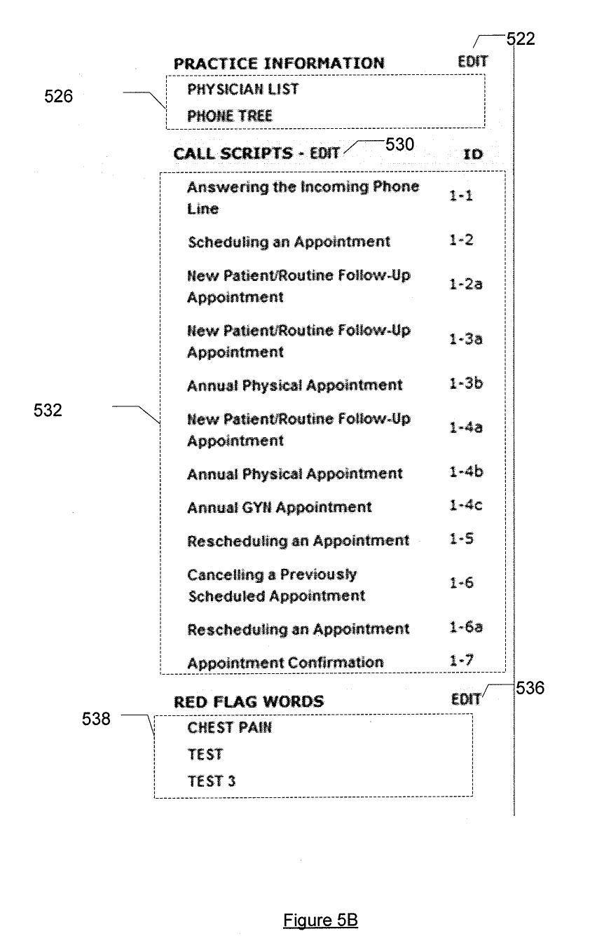

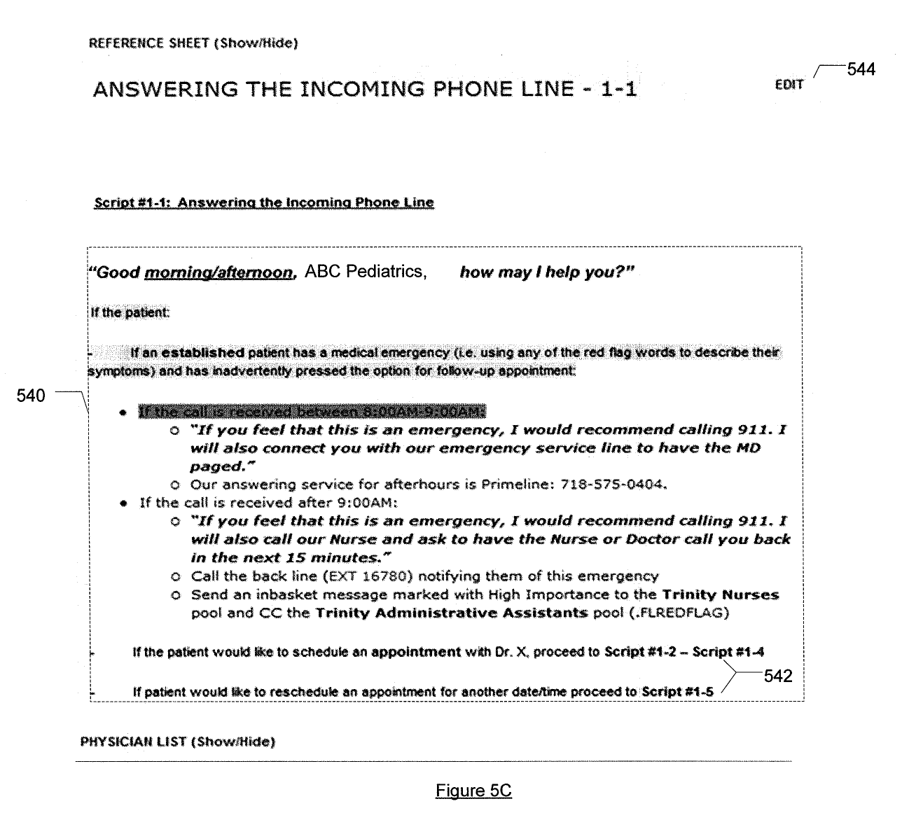

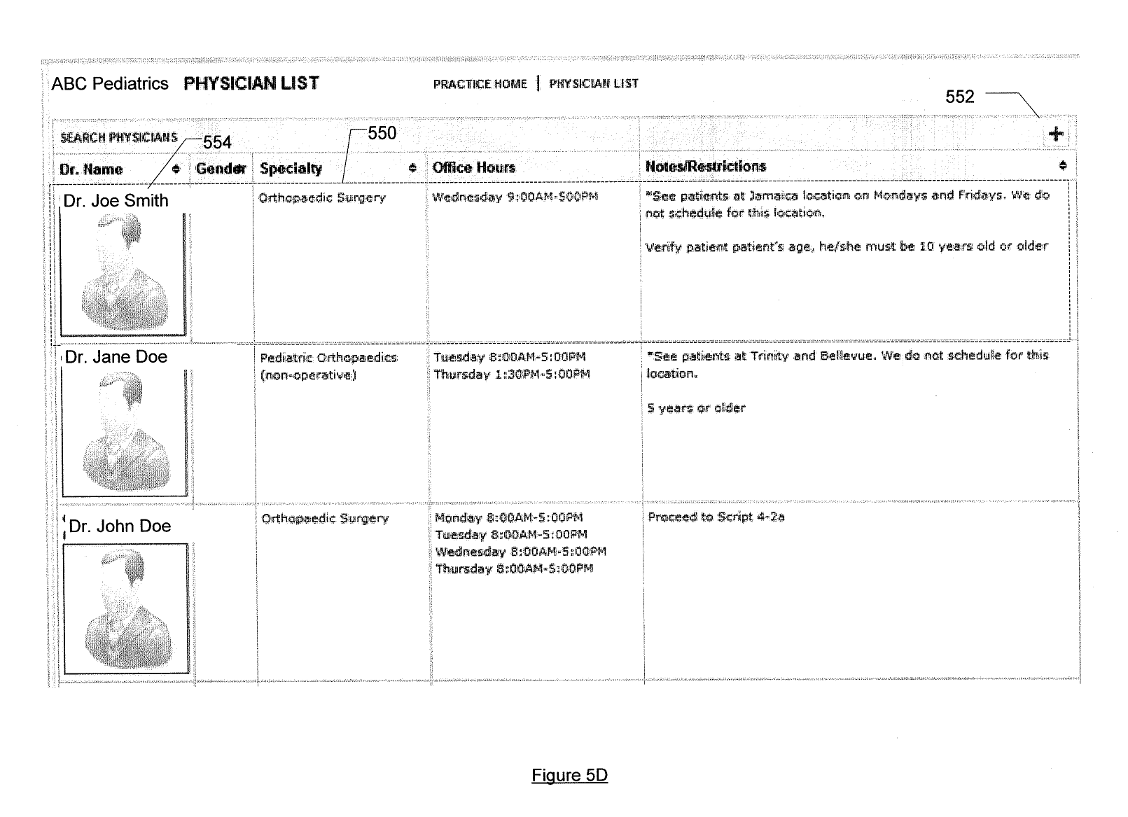

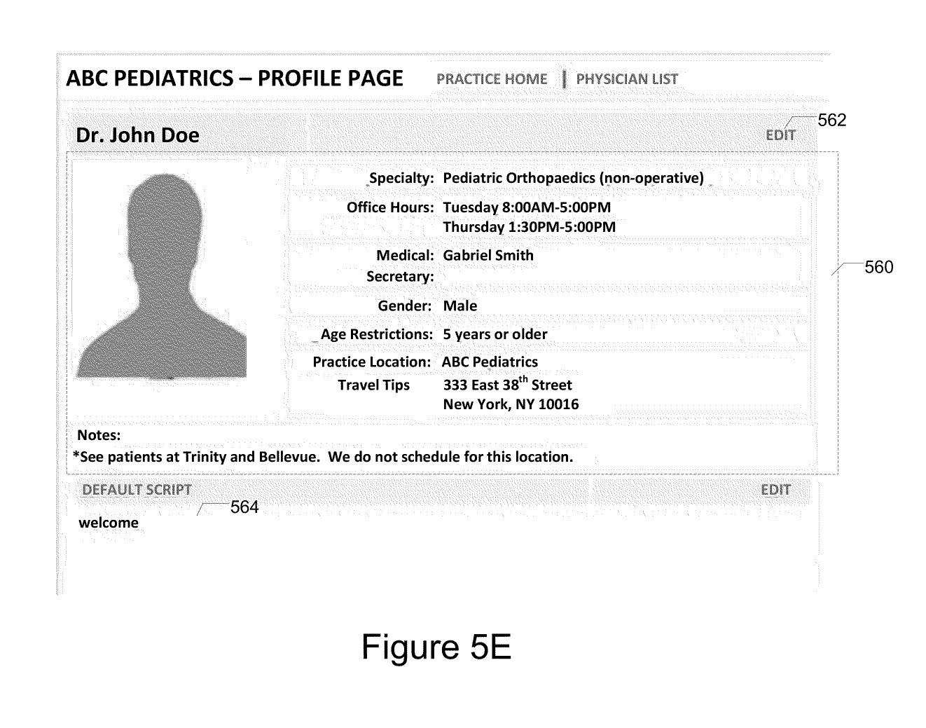

Having received the indication, at operation 350, the clinically dynamic call center apparatus 102 may be configured, such as with processor 212, clinical content management module 220, and/or the like, to cause display of the clinical content in response to the indication of the request. In some embodiments, clinical content having a publish date in the future, may not yet be displayed. Rather, the most recently published clinical content available may be displayed. The display of the clinical content is described in more detail with respect to FIGS. 5A-5E below.

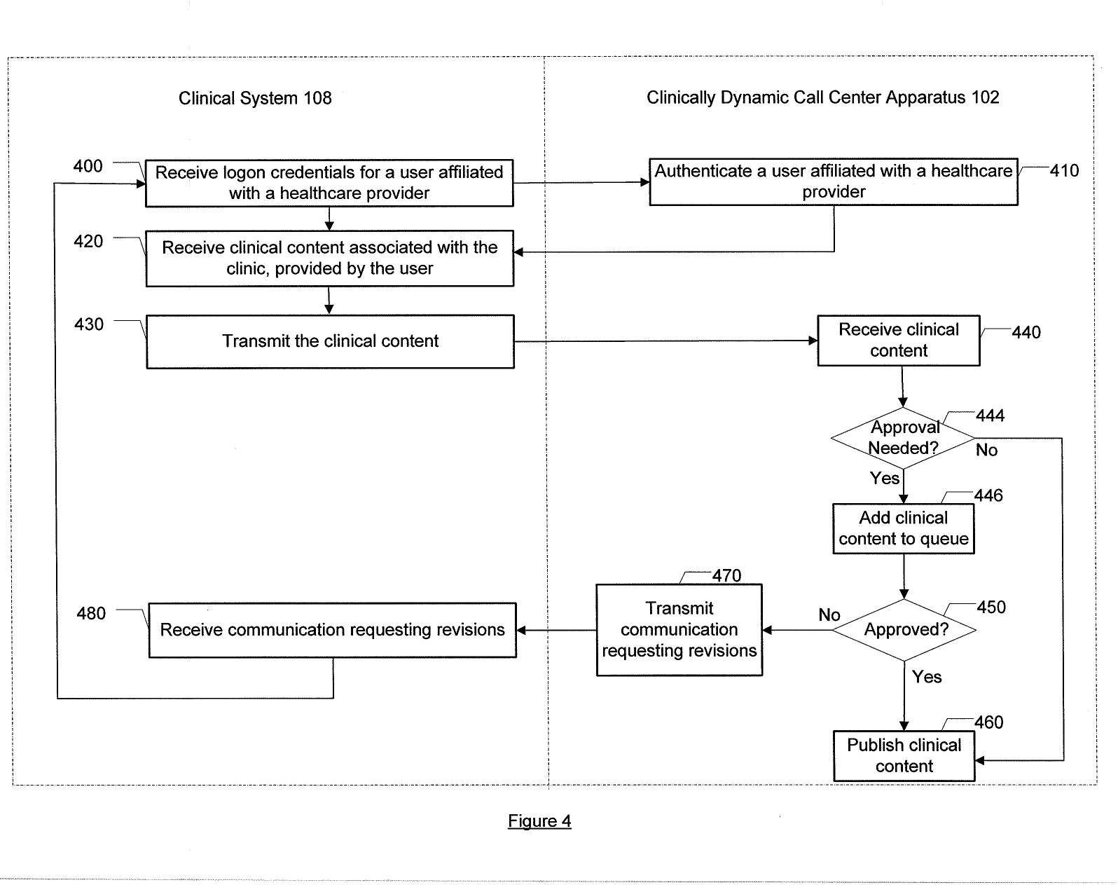

FIG. 4 is a flowchart illustrating operations for providing (e.g., editing) and publishing clinical content with a clinical system and clinically dynamic call center apparatus. Some operations are shown as being performed by clinical system 108, while some are shown as being performed by clinically dynamic call center apparatus 102. However, it will be appreciated that in some embodiments any of the operation may be performed by clinical system 108 and/or clinically dynamic call center apparatus 102.

As shown by operation 400, the clinical system 108 may be configured, such as by a user interface, communication interface, processor and/or the like, for receiving logon credentials for a user affiliated with a clinic. The logon credentials may include a username and password, for example, of a user set up to manage clinical content on behalf of the clinic. As described above, the clinically dynamic call center apparatus 102 may be configured to provide clinical content to call center agents to assist in handling inbound phone calls on behalf of the clinic with which the user is affiliated. The clinical system 108 may be used to receive the logon credentials, which may be subsequently transmitted to the clinically dynamic call center apparatus 102 for authentication.

Continuing to operation 410, the clinically dynamic call center apparatus 102 may, upon receiving the logon credentials, authenticate the user affiliated with a clinic, as described above with respect to operation 310.

Continuing to operation 420, clinical system 108 may be configured, such as by a user interface, communication interface, processor and/or the like, for receiving clinical content associated with the clinic, provided by a user. For example, the user may provide clinical content relating to a new practice. In some embodiments, the clinical content may comprise an update to existing clinical content. The clinical system 108 may therefore be used as a means for receiving new or updated clinical content from a user.

At operation 430, the clinical system 108 may be configured to transmit the clinical content to an apparatus for managing clinical content (e.g., the clinically dynamic call center apparatus 102).

At operation 440, the clinical content may be received by the clinically dynamic call center apparatus 102. The clinical content may be received by communication interface 218, for example, and may be stored to memory 214, and associated with a clinic corresponding to the clinical system 108, as described above with respect to operation 330.

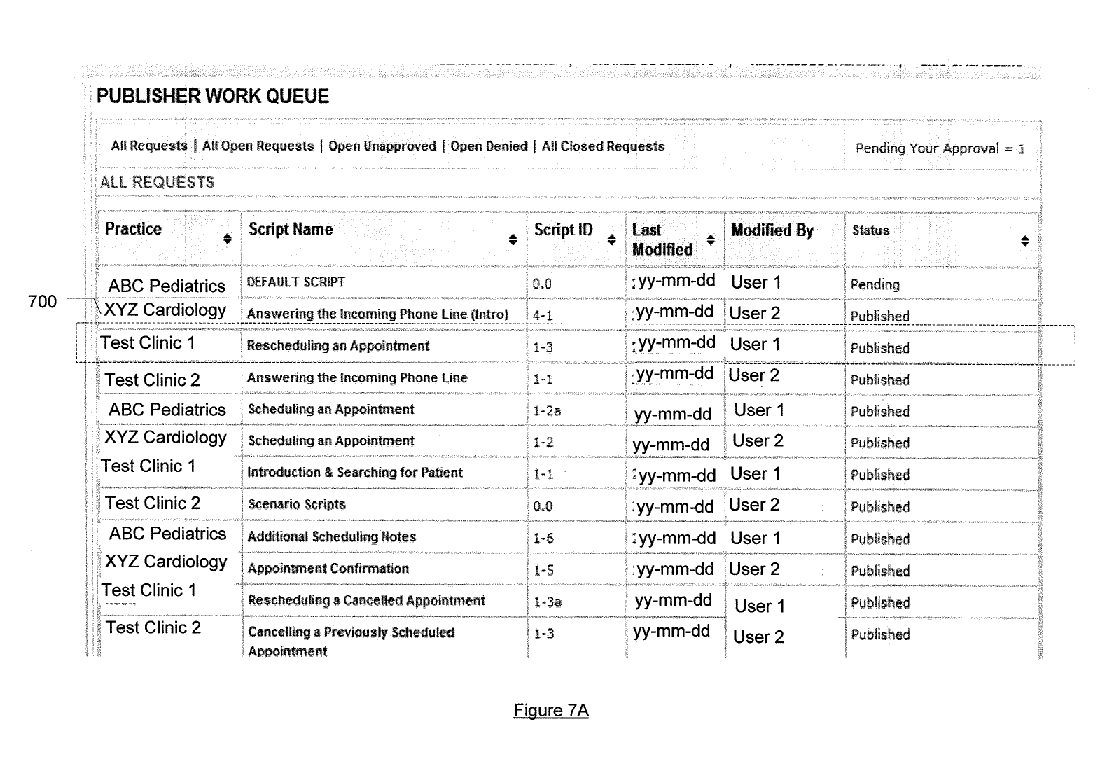

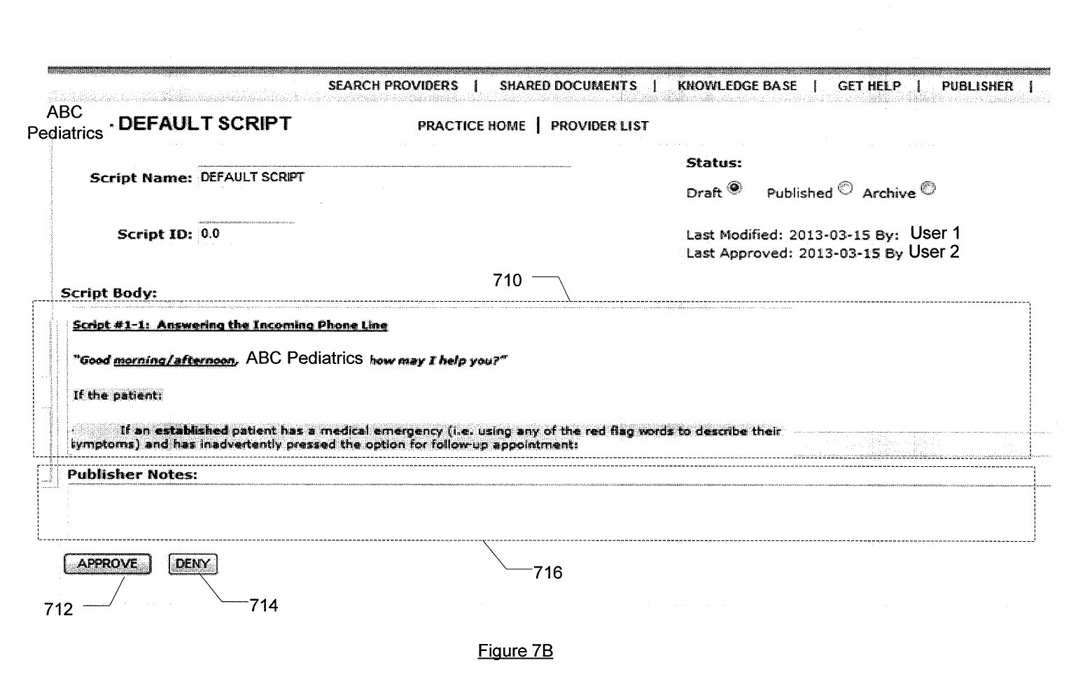

At operation 444, the clinically dynamic call center apparatus 102 may determine, such as with clinical content administration module 222, whether or not approval is needed prior to publishing the clinical content. In some embodiments in which approval is needed, the clinical content may be added to a publisher work queue for review, such as in memory 214, prior to publishing, and as shown by operation 446. The publishing queue is described in further detail with respect to FIGS. 7A-7B. The clinical content may therefore be stored on memory 214, but with a status of unpublished, until the clinical content is approved, as described in further detail with respect to FIGS. 7A-7B. Upon determining that the clinical content is approved (at operation 450), the clinical content may become published, as shown at operation 460, and may be made available for viewing by agents accessing the clinically dynamic call center apparatus 102 (e.g., via user terminal 110). The status of the clinical content may therefore change from unpublished to published.

If it is determined, at operation 444, that approval is not needed prior to publishing (e.g., such as by accessing administration settings for the particular clinic), the clinical content may be stored to memory 214 with a status of published, and may, at operation 460, be made available for viewing by agents accessing the clinically dynamic call center apparatus 102 while receiving calls.

In instances in which the clinical content administration module 222 determines approval is needed prior to publishing, and as is described in further detail with respect to FIGS. 7A-7B, a user of the clinically dynamic call center apparatus 102 accesses the unpublished clinical content, such as by user terminal 110, and/or directly on the clinically dynamic call center apparatus 102 via user interface 216 in order to determine, at operation 450, whether or not the clinical content is approved. As such, a user of the clinically dynamic call center apparatus 102 may reject the clinical content for publishing. In this instance, the clinically dynamic call center apparatus 102 may transmit a communication to the clinical system 108, requesting a revision be made. The communication may be transmitted automatically upon rejection, via communication interface 218, for example, or may include information provided by a user, explaining the rejection and including a request for an update.

Continuing to operation 480, the clinical system 108 may therefore receive the communication requesting revisions. As such, any of the operations of FIG. 4 may be repeated until the clinical content becomes published.

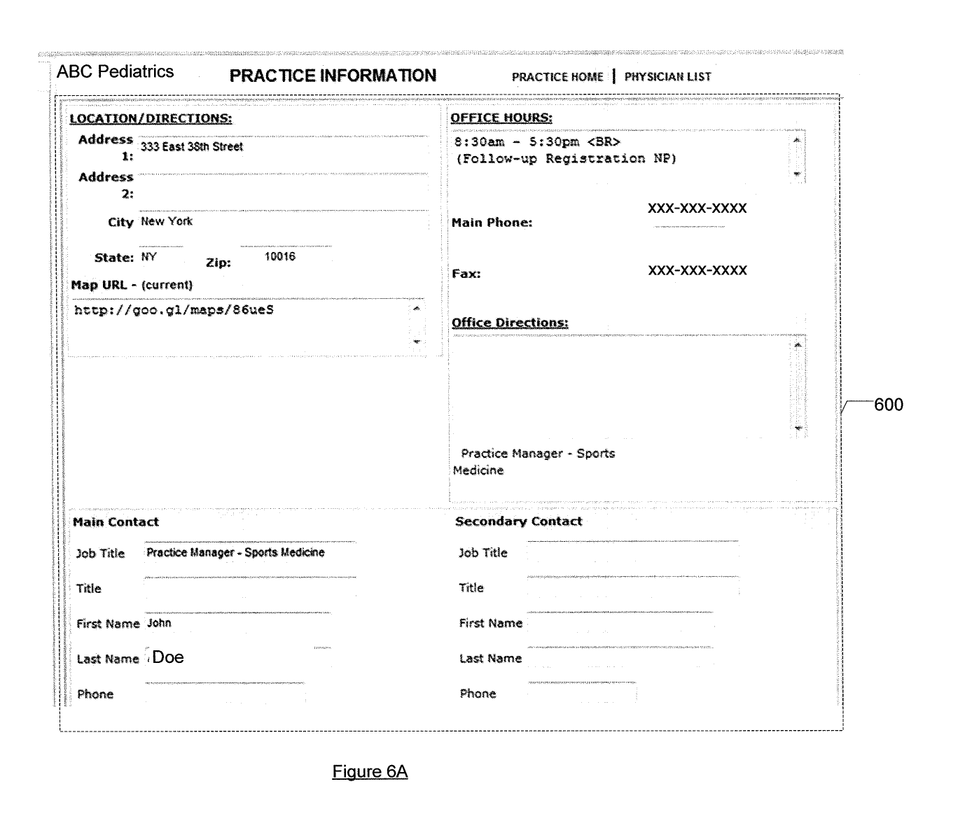

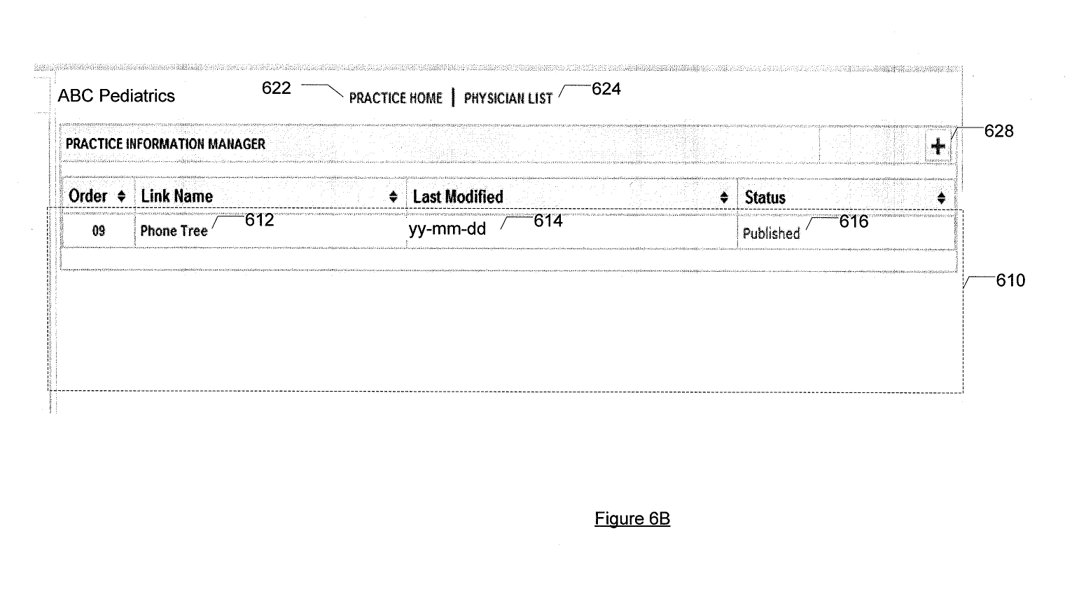

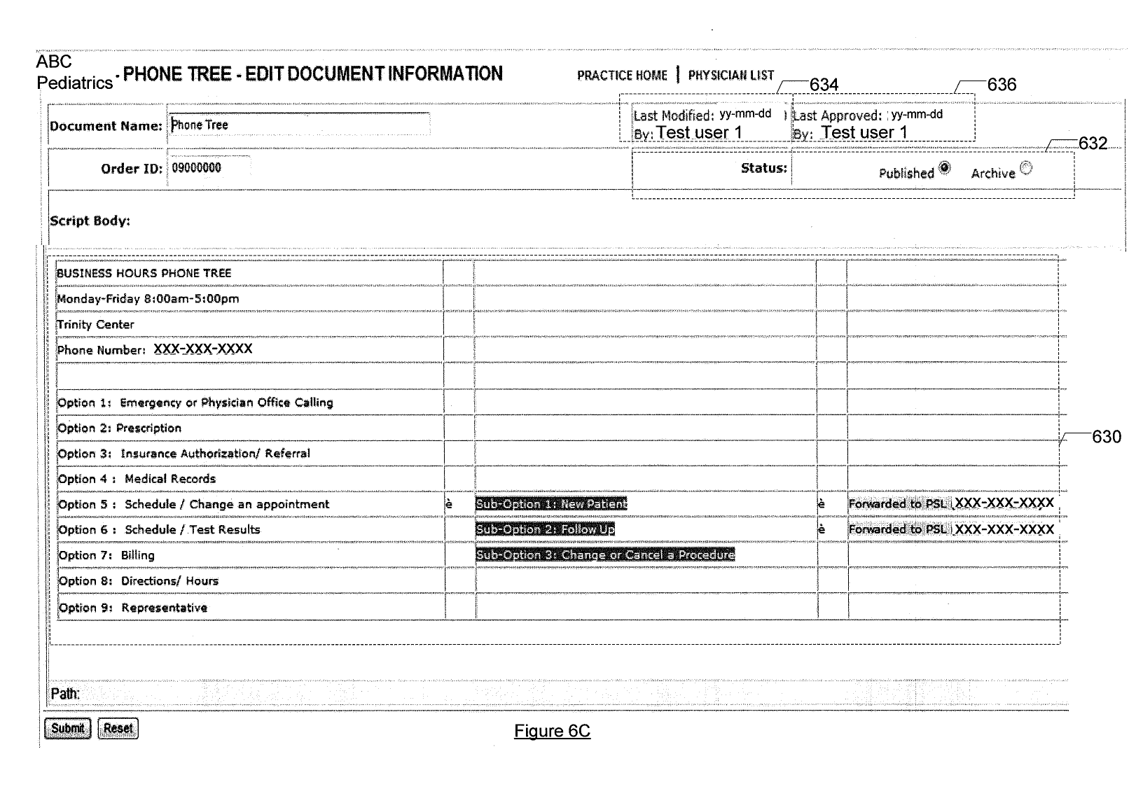

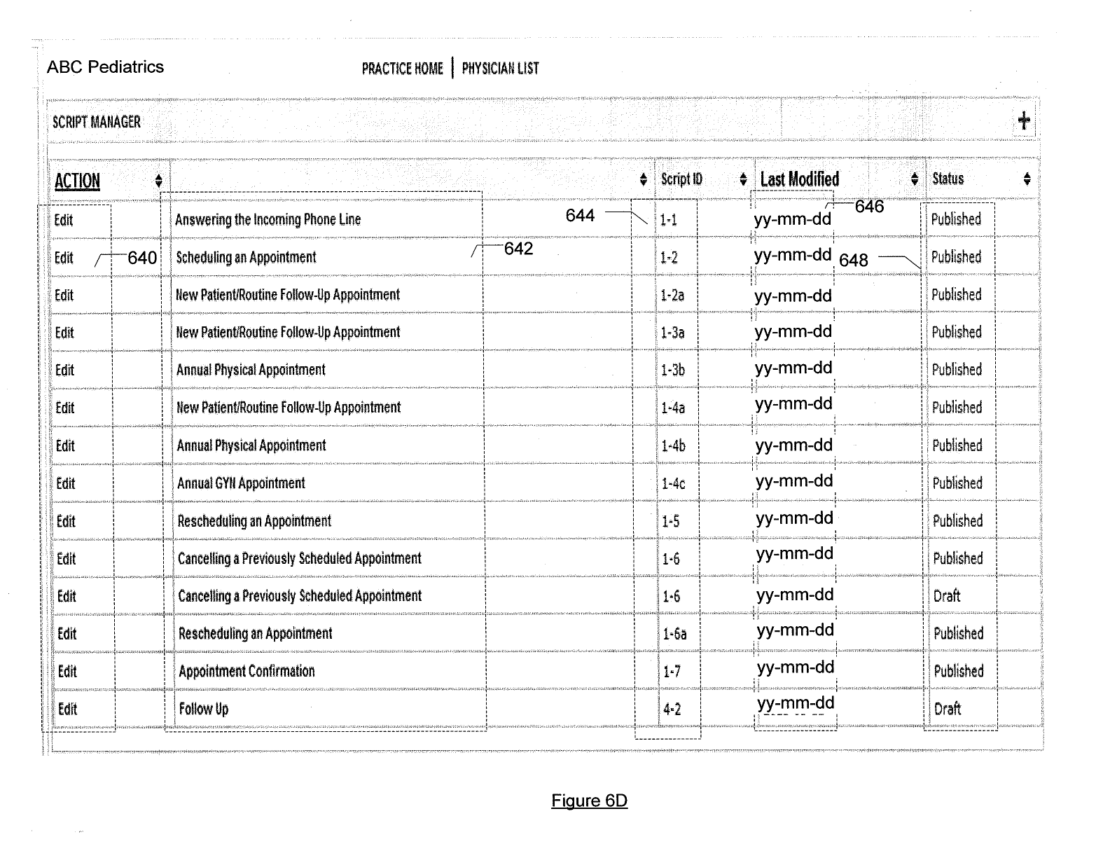

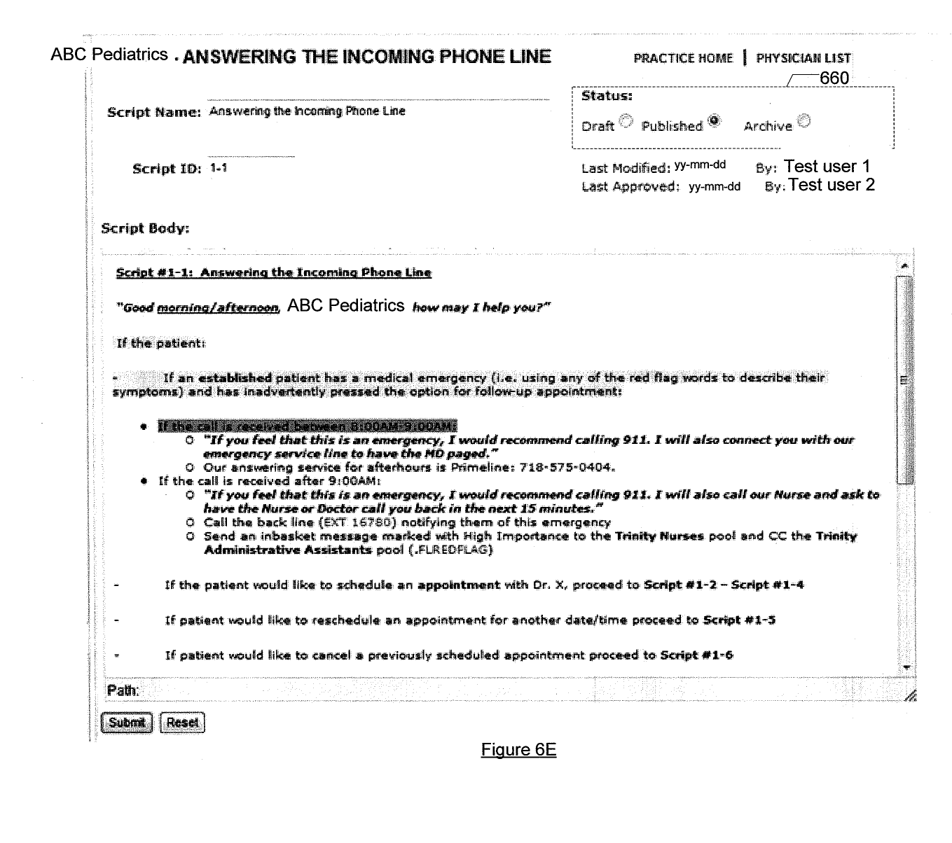

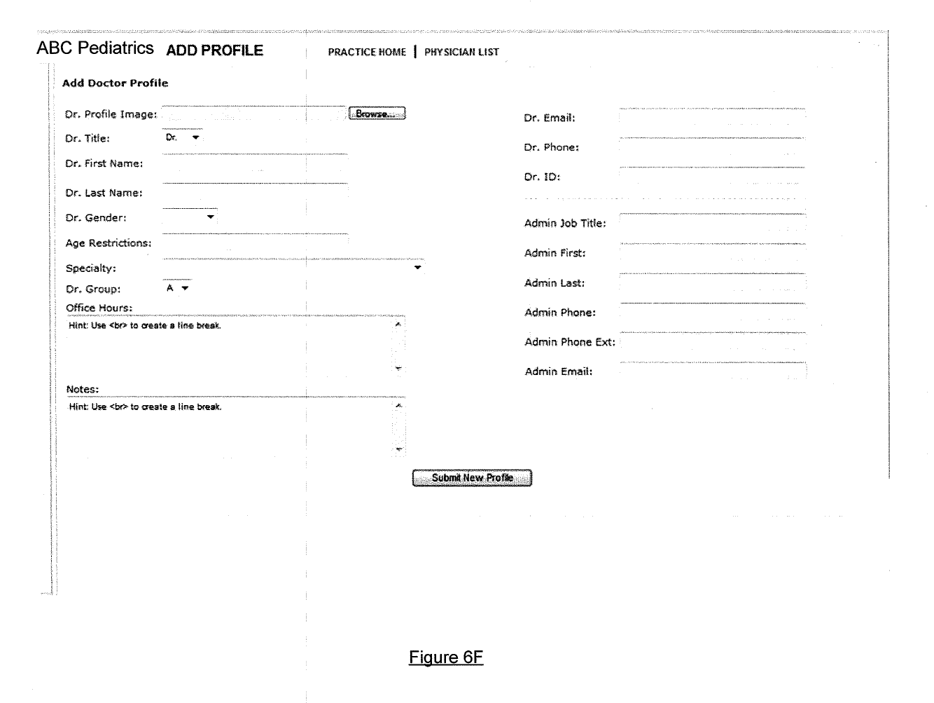

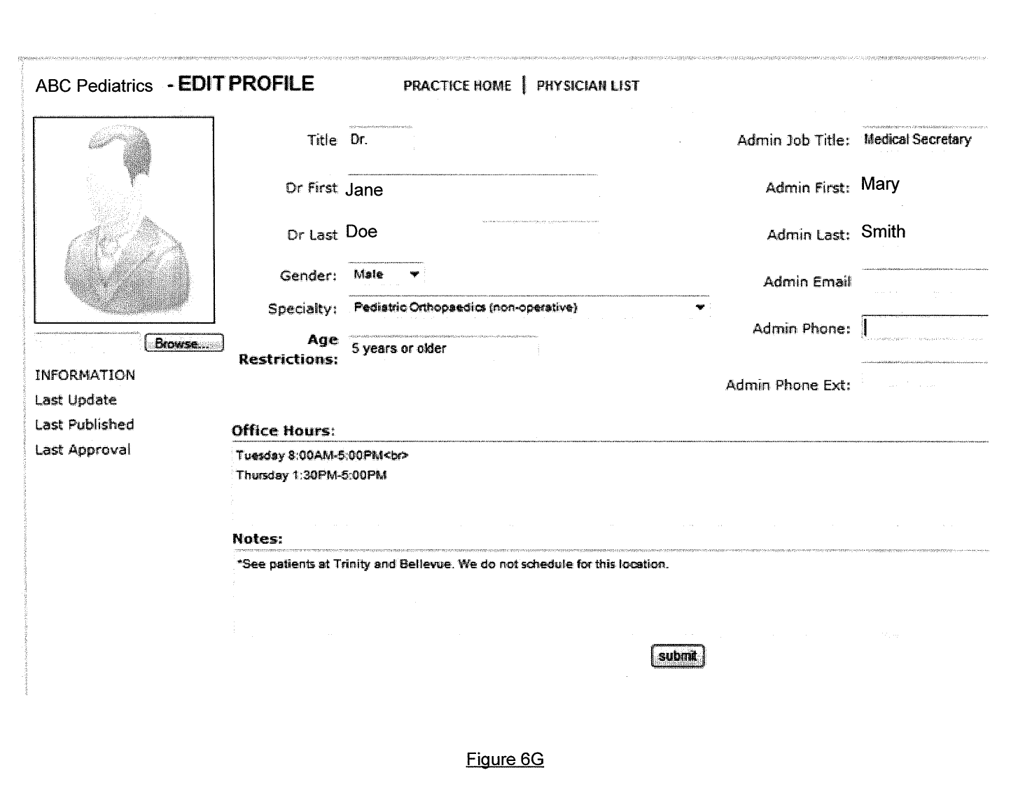

FIG. 5A is an example display that may be provided by a clinically dynamic call center apparatus 102 to an authorized user, according to an example embodiment. The display may be provided by the clinically dynamic call center apparatus 102 and may be viewed, for example, by an individual associated with a clinic via a clinical system 108 and/or by a call center agent via a user terminal 110, wherein, as described above, aspects of the clinically dynamic call center apparatus 102 may be incorporated within or associated with either or both the clinical system 108 or the user terminal 110. As shown at indicator 502, a listing of clinics (practices) may be displayed. In some embodiments, only the practices that the current user has read and/or write access to may be displayed. Upon selection of a practice, information for the particular practice, such as shown in area 506, may be displayed. The information may include, but is not limited to, an address and/or directions, office contact information, and/or the like. A user may show and/or hide the information by selecting the show/hide link 508. In some embodiments, for users having write access (e.g., permission to provide and/or edit clinical content), as determined by clinical content administration module 222, an edit link 510 may be displayed. Editing the practice information is described in further detail with respect to FIG. 6A. In addition to the practice information described above and displayed in FIG. 5A, additional information such as call scripts, physical information, and/or the like may be displayed. FIG. 5A may therefore show only a portion of the content available on the display due to space limitations of the figure. Navigation to other content may be accomplished by using the navigation of FIG. 5B, described in further detail below.

FIG. 5B is an example display that may be used to provide navigation to various displays provided by the clinically dynamic call center apparatus 102, as described herein. In some embodiments, the navigation of FIG. 5B is provided on the same display as the display of FIG. 5A, and/or other displays described herein. As shown by indicator 522, the clinically dynamic call center apparatus 102 may provide an edit link for practice information, which upon selection, may result in the clinically dynamic call center apparatus 102 providing the corresponding display such as the display of FIG. 6A. In some embodiments, the clinical content administration module 222 may determine that a user does not have permission to provide and/or edit clinical content, and the edit link 522 may not be displayed. Links such as those in area 526 may additionally or alternatively be provided to access a read-only version of a display, such as the example display of FIG. 5A. The links may be used by a call center agent, for example, to reference call scripts while on a call with a patient.

As shown by indicator 530, the clinically dynamic call center apparatus 102 may provide an edit link for call scripts, which upon selection, may result in the clinically dynamic call center apparatus 102 providing the corresponding display such as the display of FIG. 6D and/or FIG. 6E, as described below. In some embodiments, the clinical content administration module 222 may determine that a user does not have permission to provide and/or edit clinical content such as call scripts, and the edit link 530 may not be displayed. Links such as those in area 532 may additionally or alternatively be provided to access a read-only version of a display, such as the example display of FIG. 5C. The links may be used by a call center agent, for example, to access the call scripts for handling a call with a patient.

As shown by indicator 536, the clinically dynamic call center apparatus 102 may provide an edit link for red flag words, which upon selection, may result in the clinically dynamic call center apparatus 102 providing a corresponding display. In some embodiments, the clinical content administration module 222 may determine that a user does not have permission to provide and/or edit clinical content such as the red flag words, and the edit link 536 may not be displayed. Links such as those in area 538 may additionally or alternatively be provided to access a read-only version of a display. The links may be used by a call center agent, for example, upon hearing a “red flag” word recited by a patient, such as “chest pain.” A subsequent display may provide instructions to the agent for how to proceed with the call, such as urging the patient to hang up the phone and dial an emergency phone number.

FIG. 5C is an example display that may be provided by a clinically dynamic call center apparatus 102, and may be used to provide a call script to a user, such as a call center agent. Upon receiving a phone call, an agent may select the appropriate script, such as from the navigation provided in FIG. 5B, to view a display such as the display of FIG. 5C. The agent may therefore recite and/or refer to the clinical content, such as the clinical content (e.g., call script) in area 540, as provided by a user of the clinical system 108. Additionally or alternatively, a call script may include links to additional call scripts, as shown by indicator 542. As such, a representative of the clinic may link related call scripts to allow quick and easy navigation, and/or smooth transitions for the agent. Selection of a link, such as those at indicator 542, may result in the clinically dynamic call center apparatus 102 displaying the indicated call script. In some embodiments, the clinical content administration module 222 may determine a user has access to edit the particular call script, and display an edit link 544. Upon selection, a user may be directed to a display such as the display of FIG. 6E. In some embodiments, the clinical content administration module 222 may determine the user does not have write access to the call script, and link 544 may not be displayed.

FIG. 5D is an example display that may be provided by a clinically dynamic call center apparatus 102, and may be used to provide physician information related to a particular clinic. A physician listing, such as shown by indicator 550, may include a name and photograph of the physician, gender, specialty, office hours, and notes and/or restrictions regarding the particular physician. A call center agent may therefore view the physician information to provide information to a calling patient and/or to select a physician with which to schedule an appointment. If the clinical content administration module 222 indicates a current user has access to add physicians for the indicated clinic, an “add new” link 552 may additionally be provided. Such a link may direct a user to a display such as the one illustrated in FIG. 7A. In some embodiments, if the clinical content administration module 222 determines a user does not have write access, the link 552 may not be displayed or may be disabled. In some embodiments, the physician name, or another link may serve as a profile link 554, and if selected, the clinically dynamic call center apparatus 102 may provide a display such as the display of FIG. 5E.

FIG. 5E is an example display that may be provided by a clinically dynamic call center apparatus 102, and may be used to display a physician profile. The profile may include physician details 560. If the clinical content administration module 222 indicates a current user has access to edit the physician profile, an edit link 562 may be provided, and if selected, the clinically dynamic call center apparatus 102 may provide a display such as the display of FIG. 7B for editing physician information. In some embodiments, a call script 564, provided specifically for inquiries regarding the particular physician, may be displayed so that a call center agent may recite or otherwise reference the script during a call.

FIG. 6A is an example display that may be provided by a clinically dynamic call center apparatus 102, and may be used to edit practice information. In some embodiments, only a user having editor permission for the specified clinic may access a display such as that in FIG. 6A, as determined by the clinical content administration module 222, for example. As such, FIG. 6A may be displayed following selection of the edit link 510 in FIG. 5A. The inputs to FIG. 6A, such as those in area 600 may be used to provide or otherwise edit practice information such as location, direction, office hours, and/or other contact information. On initial setup of a practice, the fields of area 600 may be blank, and user may provide the clinical content. On subsequent editing of the practice information, the fields of area 600 may be prefilled with the current clinical content available on the clinically dynamic call center apparatus 102. A user may type directly into the fields of area 600 and/or copy and paste text from another application. Formatting such as font, color, and/or indentions may therefore by retained. Following submission, such as with a submit button (not illustrated), the clinical content may either be immediately available on the clinically dynamic call center apparatus 102 (and reflected on a display such as the display of FIG. 5A), or may be moved to a publisher's queue for publishing, such as described with respect to FIGS. 7A-7B.

FIG. 6B is an example display that may be provided by a clinically dynamic call center apparatus 102, and may be used to edit clinical content such as practice information. FIG. 6B may be displayed upon selection of an edit link 522 of FIG. 5B, to those users with editor permissions. In some embodiments, an area 610 may display a listing of clinical content relating to practice information including, for example, a Phone Tree associated with the practice. An edit link 612 may be used to navigate to a related edit screen to provide new clinical content or edit existing clinical content, and may result in display such as the display of FIG. 6C. Last modified timestamp 614 may provide the date and/or time of the last change to the associated clinical content. Status indicator 616 may provide a status such as “published,” meaning the clinical content is available to call center agents. A status of “draft” may indicate the clinical content needs to be approved by a user (e.g., publisher) of the clinically dynamic call center apparatus 102. In some embodiments in which the clinical content administration module 222 determines approval is not needed, following modification of clinical content by a user via the clinical system 108, the status may default to “published,” and the clinical content may be immediately available to agents and/or other users of the clinically dynamic call center apparatus 102. Indicators 622 and 624 may provide for navigation to displays of FIGS. 5A and 5D, respectively. An “add new” link 628 may additionally be provided to add new clinical content which may result in a new listing in 610. Selecting the “add new” link 628 may result in a blank version of the display of FIG. 6C, which may then be used to add new clinical content.

FIG. 6C is an example display that may be provided by a clinically dynamic call center apparatus 102, and may be used to provide or edit clinical content such as phone tree information specific to the indicated clinic. In an example embodiment, a user may be presented with such a display following selection of link 612 in FIG. 6B. The display may be prefilled with the current clinical content for the associated document (e.g., the phone tree). Similar to the display of FIG. 6A, clinical content may be typed and/or pasted into the fields of area 630. Depending on the administration settings according to the clinical content administration module 222, the clinical content may either be published, or moved to a queue for publishing. In area 632, a user may indicate whether they wish to request publishing, or archive the clinical content for future use (e.g., republishing). Area 634 may provide information regarding the last modified date and/or provider of the last modified clinical content. Area 636 may provide information regarding the last publish date and/or the user who published (e.g., approved) the clinical content.

FIG. 6D is an example display that may be provided by a clinically dynamic call center apparatus 102, and may be used to edit call scripts for a particular clinic. Selection of an edit link 640 may result in display of a display similar to FIG. 6E. Links 642 may direct a user to a read-only version of a script, such as the display of FIG. 5C. Script identifiers 644, last modified indicators 646, and status indicators 648 are also shown and provide respective information regarding the call script.

FIG. 6E is an example display that may be provided by a clinically dynamic call center apparatus 102, and may be used to provide or edit clinical content for a call script. A user having editor permissions may therefore provide or otherwise modify call scripts associated with the specified clinic. A status indicator 660 may allow a user to indicate whether they would like to save the call script as a draft, publish the call script, and/or archive the call script. Archiving may allow a user to version the call script so that previous versions may be retrieved. Saving a call script as a draft may allow a user to return to complete the call script, prior to releasing the call script for publishing. Publishing a call script may cause the call script to be immediately published (e.g., made available to agents of the call center), and/or queue the call script for publishing.

FIG. 6F is an example display that may be provided by a clinically dynamic call center apparatus 102, and may be used by an editor to add a new physician profile. As such, a user having editor permissions for a particular clinic may upload a physician photograph, and provide other information, such as name, gender, age restrictions for patients, specialty, group, office hours, notes, contact information, and related administration information. New physician profiles may be made available immediately on the clinically dynamic call center apparatus 102, or may be sent to a publishing queue as described above.

FIG. 6G is an example display that may be provided by a clinically dynamic call center apparatus 102, and may be used to edit a physician profile. As such, a user having editor permissions for a particular clinic, may upload a physician photograph, and edit other information, such as name, gender, age restrictions for patients, specialty, group, office hours, notes, contact information, and related administration information. Current clinical content used in a physician profile may be displayed by default, and a user of the clinical system 108 may edit the information accordingly. Changes to the clinical content may be made available immediately on the clinically dynamic call center apparatus 102, or may be sent to a publishing queue as described above.

FIG. 7A is an example display that may be provided by a clinically dynamic call center apparatus 102, and may be used to manage a publisher work queue. As described above with respect to FIGS. 6A-6G, users of a clinical system 108 having editor permissions may provide clinical content to be published that may need to be approved by another user, such as a publisher at the call center. The publisher work queue of FIG. 7A may therefore be used by a user with publisher permissions to manage a work queue. Request 700, for example, indicates the originating practice (e.g., clinic) of the request, a script name, script identifier, last modified date, modified by (e.g., modifying user), and status. A status may include “published” for those requests the publisher has already approved, and “pending” for those awaiting approval. Other statuses may include “denied,” for those requests returned to the clinic for further modification. A publisher may therefore sort and/or filter a work queue by any of the above fields. A user may review a request by selecting the script name, which may result in display of an approval screen such as provided in FIG. 7B.

FIG. 7B is an example display that may be provided by a clinically dynamic call center apparatus 102, and may be used by a publisher to review and/or publish clinical content. As such, requests viewed in a queue such as the work queue of FIG. 7A may be reviewed in further detail. The clinical content may be displayed in area 710 for review. A publisher may approve or deny a request for publishing clinical content with buttons 712 and 714, respectively. Area 716 may be used to provide publisher notes. A publisher denying a request may provide an indication of what changes may need to be made to the clinical content in order for the publisher to approve the change. A publisher accepting a request may provide information regarding the approval. In some embodiments the publisher notes may be left blank.

If the publisher approves the clinical content, the clinical content may be made available by the clinically dynamic call center apparatus 102 and may be viewed by call center agents. If the published denies the request, a notification communication (e.g., email) may be transmitted to the author and/or clinical system 108 notifying them of the rejection. The communication may include the publisher notes so that the author knows why the clinical content was rejected. In some embodiments, a communication indicating an approval may also be sent.

As such, the clinically dynamic call center apparatus 102 may provide clinically dynamic content to call center agents in an efficient, streamlined manner. The clinically dynamic call center apparatus 102 may be configured, with the clinical content administration module 222 to control access to users of the clinical system 108 to provide secure access to editors and publishers. The clinically dynamic call center apparatus 102 may therefore determine permissions of the user, allowing clinical content management actions for the user according to the authorization level. In some embodiments, the clinically dynamic call center apparatus 102 may automatically request approval from an additional user, such as a publisher, in instances the user is not authorized to perform an action.

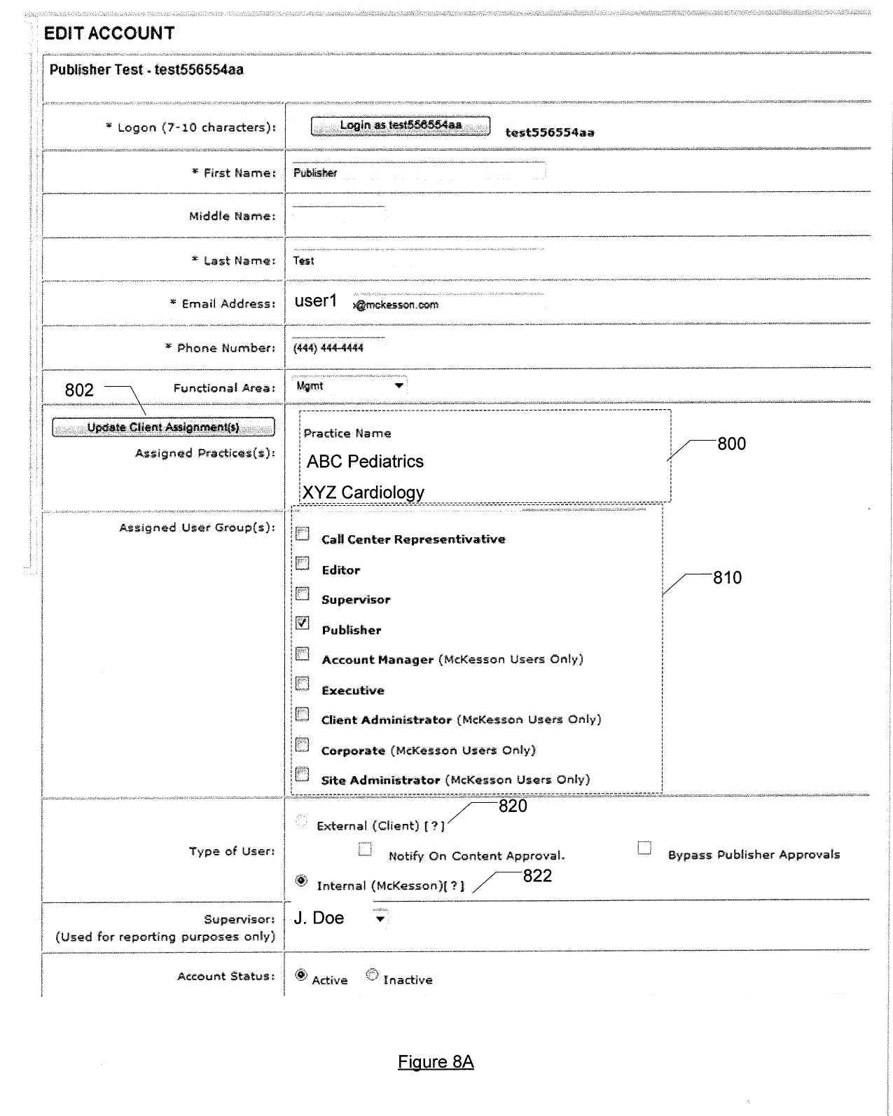

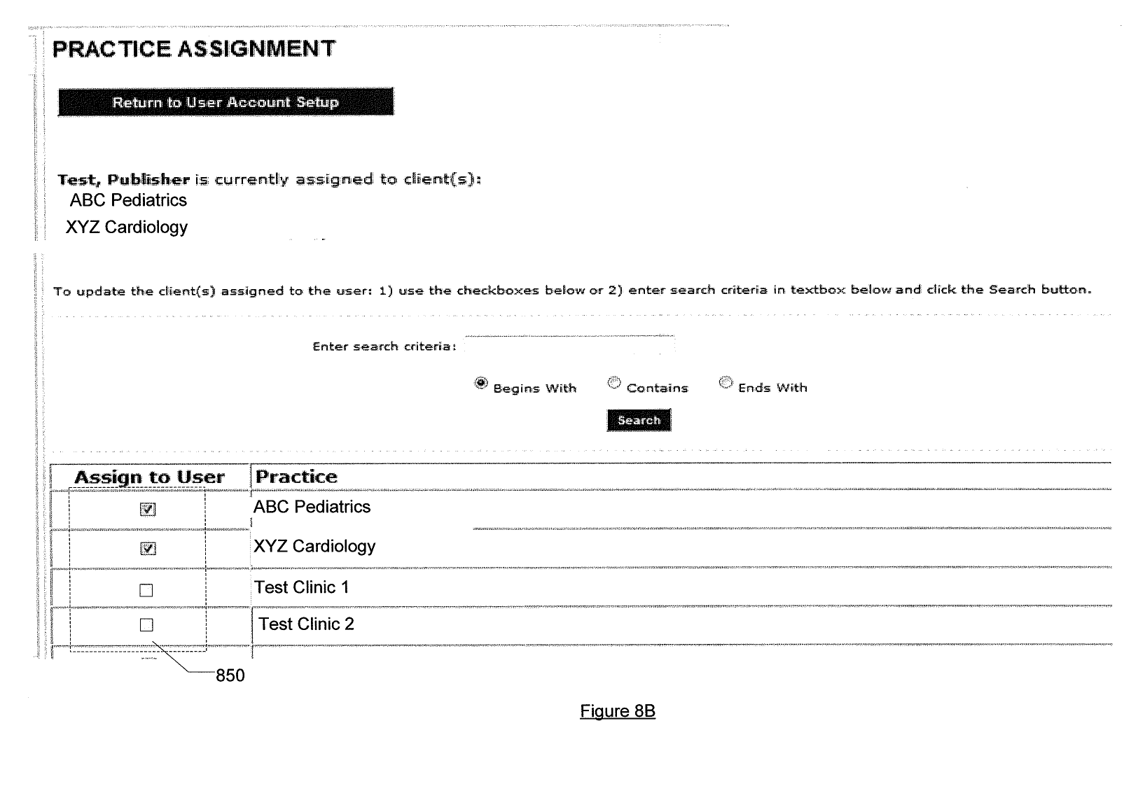

FIG. 8A is an example display that may be used to administer user permissions for the clinically dynamic call center apparatus 102. A user may be given permission to provide and/or publish clinical content for any number of clinics, as shown in area 800. A link such as link 802 may provide a display such as the display of FIG. 8B to update assigned practices (e.g., clinics). As shown in area 810, a user may be assigned various permissions, such as call center representative, editor, supervisor, publisher, account manager, executive, client administrator, corporate, and/or site administrator. A user setup as an editor may provide clinical content to the clinically dynamic call center apparatus 102, as described above. A user who is a designated publisher may approve and/or publish clinical content. A user may be considered an external user (option 820), such as a representative of a clinic, or an internal user (option 822), such as a representative of the call center.

FIG. 8B is an example display that may be used to configure clinics that a particular user has access to. Indicators 850 may be selected, indicating a user's permissions (e.g., editor, publisher) apply to clinical content for the associated clinic, or unselected, indicating a users' permission (e.g., editor, publisher) do not apply to the clinical content for the associated clinic.

FIGS. 3 and 4 illustrate flowcharts of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 214) storing instructions executable by a processor in the computing device (for example, by the processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, a clinically dynamic call center apparatus 102 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a clinically dynamic call center apparatus 102 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

That which is claimed:

1. A method for managing a call center reference tool comprising:
authenticating, with a processor, a user affiliated with a clinic;
receiving clinical content associated with the clinic, provided by the user;
storing the clinical content in association with the clinic such that the clinical content is retrievable based on an indication of the clinic;
receiving an indication of a request to view content associated with the clinic, the request initiated in response to an incoming call received at a call center regarding the clinic, wherein the call center is remote from the clinic; and
causing display of the clinical content in response to the indication of the request.

2. A method according to claim 1, further comprising:
receiving a request from the user to publish the clinical content;
inserting the request into a publisher work queue; and
causing display of the request to the publisher, wherein the publisher is remote from the clinic.

3. A method according to claim 2, further comprising:
receiving an indication of approval of the request; and
publishing the clinical content so that the clinical content is available to call center agents.

4. A method according to claim 2, further comprising:
receiving an indication of denial of the request;
receiving publisher notes from the publisher, wherein the publisher notes include a reason for denial; and
transmitting a communication notifying the clinic of the denial, wherein the communication comprises the publisher notes.

5. A method according to claim 1, further comprising:
receiving a user-specified publishing date, wherein causing display of the clinical content occurs on and after the user-specified publishing data.

6. An apparatus comprising at least one processor and at least one memory including computer program code, the at least one memory and the computer program code configured to, with the processor, cause the device to at least:
authenticate a user affiliated with a clinic;
receive clinical content associated with the clinic, provided by the user;
store the clinical content in association with the clinic such that the clinical content is retrievable based on an indication of the clinic;
receive an indication of a request to view content associated with the clinic, the request initiated in response to an incoming call received at a call center regarding the clinic, wherein the call center is remote from the clinic; and
cause display of the clinical content in response to the indication of the request.

7. The apparatus according to claim 6, wherein the at least one memory and the computer program code are further configured to, with the processor, cause the device to at least:
receive a request from the user to publish the clinical content;
insert the request into a publisher work queue; and
cause display of the request to the publisher, wherein the publisher is remote from the clinic.

8. The apparatus according to claim 7, wherein the at least one memory and the computer program code are further configured to, with the processor, cause the device to at least:
receive an indication of approval of the request; and
publish the clinical content so that the clinical content is available to call center agents.

9. An apparatus according to claim 7, wherein the at least one memory and the computer program code are further configured to, with the processor, cause the device to at least:
receive an indication of denial of the request;
receive publisher notes from the publisher, wherein the publisher notes include a reason for denial; and
transmit a communication notifying the clinic of the denial, wherein the communication comprises the publisher notes.

10. An apparatus according to claim 6, wherein the at least one memory and the computer program code are further configured to, with the processor, cause the device to at least:
receive a user-specified publishing date, wherein causing display of the clinical content occurs on and after the user-specified publishing data.

11. A computer program product comprising at least one non-transitory computer-readable storage medium having computer-executable program code instructions stored therein, the computer-executable program code instructions comprising program code instructions to:
authenticate a user affiliated with a clinic;
receive clinical content associated with the clinic, provided by the user;
store the clinical content in association with the clinic such that the clinical content is retrievable based on an indication of the clinic;
receive an indication of a request to view content associated with the clinic, the request initiated in response to an incoming call received at a call center regarding the clinic, wherein the call center is remote from the clinic; and
cause display of the clinical content in response to the indication of the request.

12. A computer program product according to claim 11, wherein the computer-executable program code instructions further comprise program code instructions to:
receive a request from the user to publish the clinical content;
insert the request into a publisher work queue; and
cause display of the request to the publisher, wherein the publisher is remote from the clinic.

13. A computer program product according to claim 12, wherein the computer-executable program code instructions further comprise program code instructions to:
receive an indication of approval of the request; and
publish the clinical content so that the clinical content is available to call center agents.

14. A computer program product according to claim 12, wherein the computer-executable program code instructions further comprise program code instructions to:
receive an indication of denial of the request;
receive publisher notes from the publisher, wherein the publisher notes include a reason for denial; and
transmit a communication notifying the clinic of the denial, wherein the communication comprises the publisher notes.

15. A computer program product according to claim 11, wherein the computer-executable program code instructions further comprise program code instructions to:
receive a user-specified publishing date, wherein causing display of the clinical content occurs on and after the user-specified publishing data.

16. A system comprising:
(a) a device configured to:
receive logon credentials for a user affiliated with a clinic;
receive clinical content associated with the clinic; and
transmit the clinical content to an apparatus for managing clinical content; and
(b) an apparatus, remote from the device, configured to:
authenticate the user;
receive the clinical content; and
store the clinical content in association with the clinic such that the clinical content is retrievable based on an indication of the clinic;
receive an indication of a request to view content associated with the clinic, the request initiated in response to an incoming call received at a call center regarding the clinic, wherein the call center is remote from the clinic; and
cause display of the clinical content in response to the indication of the request.

17. A system according to claim 16, wherein the apparatus is further configured to:
receive a request from the user to publish the clinical content;
insert the request into a publisher work queue; and
cause display of the request to the publisher, wherein the publisher is remote from the clinic.

18. A system according to claim 17, wherein the apparatus is further configured to:
receive an indication of approval of the request; and
publish the clinical content so that the clinical content is available to call center agents.

19. A system according to claim 17, wherein the apparatus is further configured to:
receive an indication of denial of the request;
receive publisher notes from the publisher, wherein the publisher notes include a reason for denial; and
transmit a communication notifying the clinic of the denial, wherein the communication comprises the publisher notes.

20. A system according to claim 16, wherein the apparatus is further configured to:
receive a user-specified publishing date, wherein causing display of the clinical content occurs on and after the user-specified publishing data.
